(19) United States
(12) Patent Application Publication
(10) Pub. No.: US 2018/0324640 A1
(43) Pub. Date: Nov. 8, 2018

(54) Vehicle-Mounted Gateway Device, Electronic Control Device, and Vehicle-Mounted Network System

(71) Applicant: Hitachi Automotive Systems, Ltd., Hitachinaka-shi Ibaraki (JP)

(72) Inventors: Shuhei KANEKO, Hitachinaka-shi, Ibaraki (JP); Kazuhiro NAKANISHI, Hitachinaka-shi, Ibaraki (JP)

(73) Assignee: Hitachi Automotive Systems, Ltd., Hitachinaka-shi, Ibaraki (JP)

(21) Appl. No.: 15/772,217

(22) PCT Filed: Oct. 21, 2016
(86) PCT No.: PCT/JP2016/081193

§ 371 Date: Apr. 30, 2018

(30) Foreign Application Priority Data
Nov. 25, 2015 (JP) 2015-229274

(51) Int. Cl. H04W 28/06; H04W 4/40; H04W 88/16; B60R 16/023; H04W 92/02; H04L 29/06; H04L 12/807

(52) U.S. Cl. CPC H04W 28/065; H04W 4/40; H04W 88/16; H04L 67/12; H04W 92/02; H04L 29/06068; H04L 47/27; B60R 16/023

(57) ABSTRACT

Provided is a relay technology capable of limiting transfer latency in a vehicle-mounted network. A vehicle-mounted gateway device according to the present invention: consolidates within a first data portion included in a large sized first communication frame a plurality of second data portions each included in a small sized second communication frame, thereby generating the first communication frame; and relays the first communication frame that has been generated.

### TECHNICAL FIELD

The present invention relates to a vehicle-mounted network.

### BACKGROUND ART

In recent years, a plurality of electronic control units (ECUs) are mounted in vehicles. ECUs are installed in various places in a vehicle. The plurality of ECUs cooperate to realize one vehicle-mounted application. For that purpose, data communication between the ECUs is necessary, and each ECU is connected by a communication line to constitute a vehicle-mounted network.

Since ECUs are installed in various locations in the vehicle, a vehicle-mounted network is configured for each installation location. Furthermore, a vehicle-mounted gateway device for relaying communication between each vehicle-mounted network is arranged, and the ECU connected to each vehicle-mounted network can communicate via the vehicle-mounted gateway.

At present, a control area network (CAN) is widely used as a communication protocol on vehicle-mounted networks. Meanwhile, in recent years, an advanced cooperative control system such as automatic driving control has been developed. In such a system, it is actively studied to apply a high-speed communication protocol such as Ethernet (registered trademark).

Under such circumstances, it is anticipated that the newly added configuration of a vehicle-mounted network to which Ethernet is applied will be the mainstream for the vehicle-mounted network constructed by the conventional communication protocol such as CAN. Therefore, in a vehicle-mounted gateway device that relays communication between vehicle-mounted networks using different communication protocols, efficient relay processing is required.

The following PTLs 1 and 2 describe the prior art for relaying communication between networks using different communication protocols.

### CITATION LIST

### Patent Literature

PTL 1: JP 2008-294935 A

PTL 2: JP 2013-013083 A

### SUMMARY OF INVENTION

### Technical Problem

In a system in which a plurality of ECUs cooperate to control vehicles in a coordinated manner, it is required that each ECU synchronously performs transmission as fast as possible. Therefore, low latency of a transfer time is required as basic performance of a vehicle-mounted gateway device. However, when a transfer destination conflicts, the vehicle-mounted gateway device generally firstly transfers communication frames with high priority, but this increases the latency of the transfer time for the communication frame with low priority, and this causes a problem in cooperative control between ECUs. This basic performance and problem are also applicable when relaying a communication frame from CAN to Ethernet.

The present invention has been made in view of the above problems, and it is an object of the present invention to provide a relay technology capable of suppressing transfer latency in a vehicle-mounted network to a low level.

### Solution to Problem

A vehicle-mounted gateway device according to the present invention consolidates within a first Data portion included in a large sized first communication frame a plurality of second Data portions each included in a small sized second communication frame, thereby generating the first communication frame, and relays the first communication frame that has been generated.

### Advantageous Effects of Invention

According to a vehicle-mounted gateway device of the present invention, latency of a transfer time can be kept low even in the case where transfer destinations conflict.

### BRIEF DESCRIPTION OF DRAWINGS

FIG. 1 is a configuration diagram of a vehicle-mounted network system 1 according to a first embodiment.

FIG. 2 is a functional block diagram showing a configuration of a vehicle-mounted gateway device 2.

FIG. 3 is a flowchart showing processing in which the vehicle-mounted gateway device 2 transfers a CAN frame to an Ethernet network.

FIG. 4 is a conceptual diagram for explaining processing of storing the CAN frame into an Ethernet frame in the flowchart of FIG. 3.

FIG. 5 is a functional block diagram showing a configuration of an ECU 4.

FIG. 6 is a flowchart for explaining processing of extracting a CAN message from the Ethernet frame by the ECU 4.

FIG. 7 is a time chart for explaining time required for transfer of a plurality of CAN frames when transfer destinations conflict.

FIG. 8 is a configuration example of the vehicle-mounted network system 1 in which a monitor device 5 simulating the ECU 4 is connected to an Ethernet network in place of the ECU 4.

FIG. 9 is an example of a routing table 22 of the vehicle-mounted gateway device 2.

FIG. 10 is a time chart for explaining processing in which the vehicle-mounted gateway device 2 transfers a CAN frame.

FIG. 11 is a view showing a result of monitoring an Ethernet frame shown in FIG. 10 by the monitor device 5.

### DESCRIPTION OF EMBODIMENTS

### First Embodiment

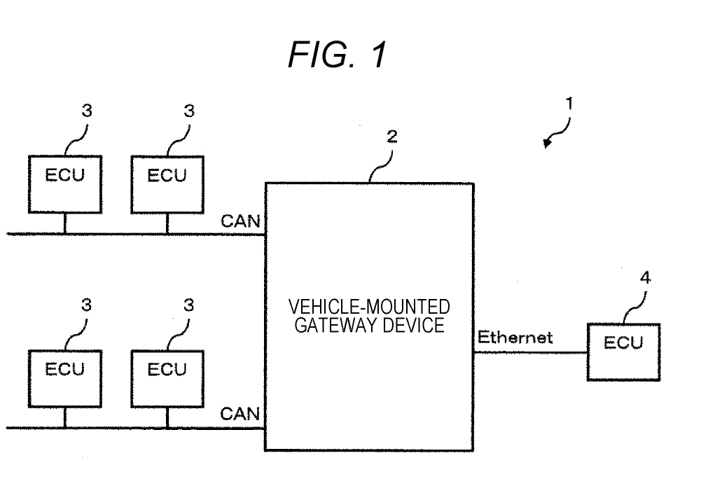

FIG. 1 is a block diagram of a vehicle-mounted network system 1 according to the first embodiment of the present invention. A vehicle-mounted network system 1 is a network system installed in a vehicle, and includes a vehicle-mounted network that transmits and receives a communication frame using a CAN and a vehicle-mounted network that transmits and receives a communication frame using Ethernet. A vehicle-mounted gateway device 2 is a device that relays communication between these vehicle-mounted networks. ECU 3 is an electronic control device belonging a CAN network. ECU 4 is an electronic control device belonging to an Ethernet network.

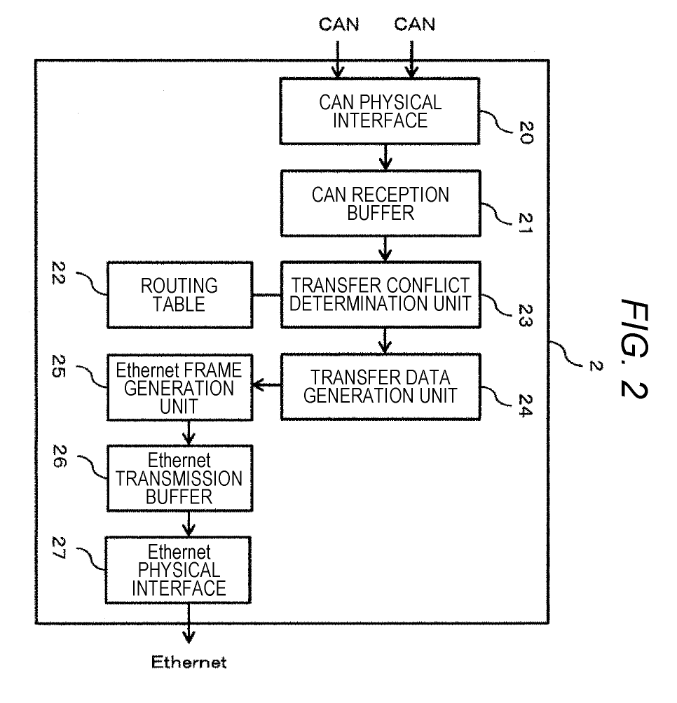

FIG. 2 is a functional block diagram showing a configuration of the vehicle-mounted gateway device 2. The vehicle-mounted gateway device 2 includes a CAN physical interface 20, a CAN reception buffer 21, a routing table 22, a transfer conflict determination unit 23, a transfer data generation unit 24, an Ethernet frame generation unit 25, an Ethernet transmission buffer 26, and an Ethernet physical interface 27.

The CAN physical interface 20 is a physical interface with the CAN network. The CAN reception buffer 21 is a data table that stores a CAN frame received by the CAN physical interface 20, and the routing table 22 is a data table that defines the transfer destination of the received CAN frame. The transfer conflict determination unit 23 determines a transfer destination of the CAN frame stored in the CAN reception buffer 21 according to the routing table 22 and determines whether there is a CAN frame of which a transfer destination conflicts. The transfer data generation unit 24 generates a data portion (Payload portion) of the communication frame to be transferred to the Ethernet network. The Ethernet frame generation unit 25 generates an Ethernet frame using the data portion generated by the transfer data generation unit 24. The Ethernet transmission buffer 26 is a buffer for temporarily storing the Ethernet frame before sending it to the Ethernet network. The Ethernet physical interface 27 is a physical interface with the Ethernet network.

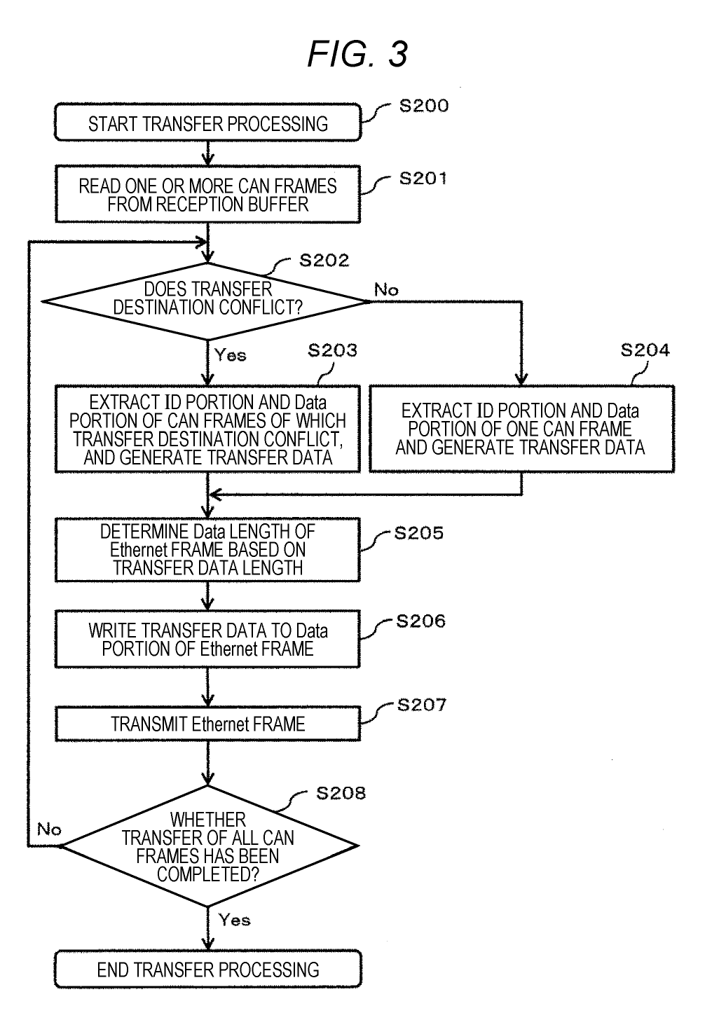

FIG. 3 is a flowchart for explaining processing in which the vehicle-mounted gateway device 2 transfers the CAN frame to the Ethernet network. Each step of FIG. 3 will be described below.

(FIG. 3: steps S200 to S201)

The vehicle-mounted gateway device 2 starts the present flow chart periodically or in response to interruption processing or the like (S200), for example. The transfer conflict determination unit 23 reads one or more CAN frames from the CAN reception buffer (S201).

(FIG. 3: step S202)

The transfer conflict determination unit 23 determines the transfer destination of the CAN frame read in step S201 according to the routing table 22. The transfer conflict determination unit 23 determines whether there is a CAN frame of which a transfer destination conflicts. “Transfer destination conflicts” means that there are a plurality of communication frames to be transferred to the same vehicle-mounted network. In the network configuration of FIG. 1, this corresponds to the case where there are a plurality of CAN frames to be transferred to the Ethernet network. If there is a CAN frame of which a transfer destination conflicts, the processing proceeds to step S203, and if not, the processing proceeds to step S204.

(FIG. 3: step S203)

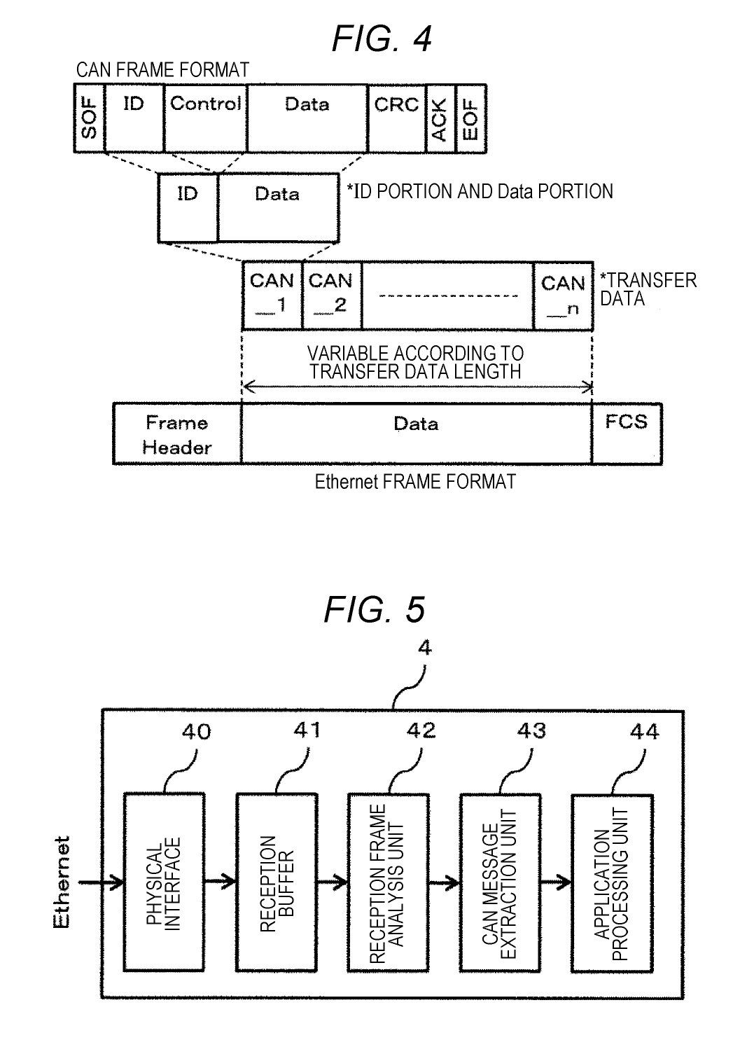

The transfer data generation unit 24 extracts and consolidates an ID portion and the Data portion of each CAN frame of which a transfer destination conflicts to generate the data portion of the communication frame transferred to the Ethernet network. The frame structure of the CAN frame and the frame structure of the Ethernet frame are illustrated in FIG. 4 which will be described later.

(FIG. 3: step S204)

The transfer data generation unit 24 extracts the ID portion and the Data portion of one CAN frame and generates the data portion of the communication frame to transfer to the Ethernet network.

(FIG. 3: steps S205 to S206)

The Ethernet frame generation unit 25 determines a Data length of the Ethernet frame transmitted to the Ethernet network based on a length of the data portion (transfer data) generated in step S203 or S204 (S205). The Ethernet frame generation unit 25 stores the transfer data in the Data portion of the Ethernet frame (S206).

(FIG. 3: step S207)

The Ethernet frame generation unit 25 generates an Ethernet frame to be transmitted to the Ethernet network, stores it in the Ethernet transmission buffer 26, and sets it to be transmitted. The Ethernet physical interface 27 transmits the Ethernet frame stored in the Ethernet transmission buffer 26.

(FIG. 3: step S208)

The vehicle-mounted gateway device 2 determines whether transfer of all the CAN frames read from the CAN reception buffer 21 has been completed. If it has been completed, this flowchart is ended, and if there are remaining frames to be transferred, the flow returns to step S202 and similar processing is performed on the remaining CAN frames.

FIG. 4 is a conceptual diagram for explaining the processing of storing the CAN frame in the Ethernet frame in the flowchart of FIG. 3. An upper part of FIG. 4 shows a frame format of the CAN frame. A lower part of FIG. 4 shows a frame format of the Ethernet frame. A middle part of FIG. 4 shows a processing process.

The CAN frame has an SOF portion, an ID portion, a Control portion, a Data portion, a CRC portion, an ACK portion, and an EOF portion. The SOF portion is a field indicating a start of the frame. The ID portion is a field representing an identifier corresponding to a type of a communication message. The Control portion is a field indicating a reserved bit and the Data length of the Data portion. The Data portion is a field representing a communication message. The CRC portion is a field representing a transmission error of frame. The ACK portion is a field indicating a signal of confirmation of normal reception. The EOF portion is a field indicating an end of frame.

The Ethernet frame has a Frame Header portion, a Data portion, and an FCS portion. The Frame Header portion is a field indicating additional information other than the communication message such as the destination and the Data length. The Data portion is a field representing the communication message. The FCS portion is a field indicating the transmission error of the frame.

Considering the configuration of the CAN frame, the information transferred from the CAN network to the Ethernet network should have at least the ID portion and the Data portion corresponding to the communication message. Accordingly, the transfer data generation unit 24 generates transfer data using the ID portion and the Data portion of the CAN frame in steps S203 to S204 of FIG. 3. If the transfer destination conflicts (i.e., if the transfer destinations of a plurality of CAN frames are the same Ethernet network), the ID portion and Data portion of the conflicting CAN frames can be packaged as one transfer data.

The Ethernet frame generation unit 25 determines the Data length of the Ethernet frame according to the length of the transfer data. Therefore, the Ethernet frame has a variable length according to the number of CAN frames transferred to the Ethernet network.

FIG. 5 is a functional block diagram showing the configuration of the ECU 4. The ECU 4 includes a physical interface 40, a reception buffer 41, a reception frame analysis unit 42, a CAN message extraction unit 43, and an application processing unit 44.

The physical interface 40 is a physical interface with the Ethernet network. The reception buffer 41 stores the received Ethernet frame. The reception frame analysis unit 42 analyzes the received Ethernet frame. The CAN message extraction unit 43 extracts a CAN message stored in the Data portion of the received Ethernet frame. The application processing unit 44 executes a corresponding application using the extracted CAN message.

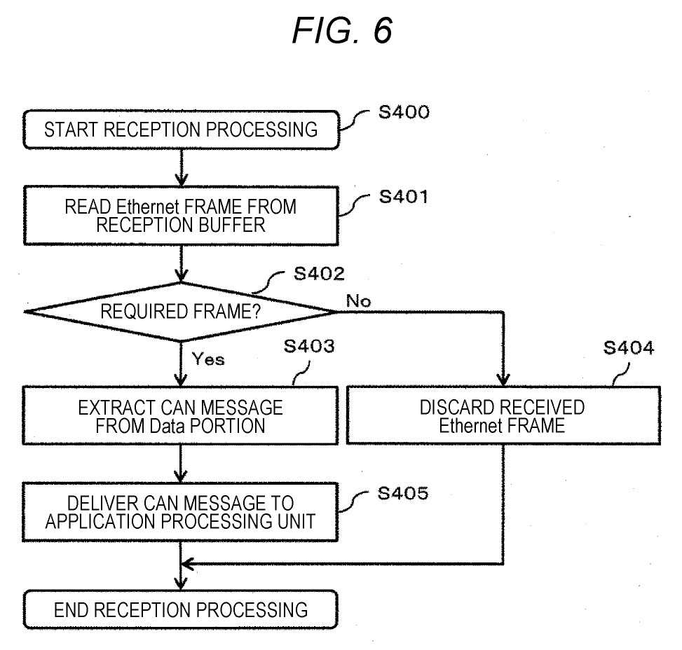

FIG. 6 is a flowchart for explaining processing in which the ECU 4 extracts a CAN message from the Ethernet frame. Each step of FIG. 6 will be described below.

(FIG. 6: steps S400 to S401)

The ECU 4 starts the present flow chart, for example, periodically or in response to interruption processing or the like, for example (S400). The reception frame analysis unit 42 reads the Ethernet frame from the reception buffer 41 (S401).

(FIG. 6: step S402)

The reception frame analysis unit 42 determines whether the received Ethernet frame is necessary for its own device (ECU 4). For example, if the electronic control device other than the ECU 4 connected to the Ethernet network is not planning to receive the communication frame from the CAN network, it can be determined that these ECUs do not need the Ethernet frame transferred from the vehicle-mounted gateway device 2. If the received Ethernet frame is required, the processing proceeds to step S403, and if it is unnecessary, the processing proceeds to step S404.

(FIG. 6: step S403)

The CAN message extraction unit 43 extracts a CAN message (the ID portion and the Data portion of the CAN frame) from the Data portion of the reception frame. If the Data portion stores a plurality of CAN messages, the CAN message extraction unit 43 extracts each CAN message.

(FIG. 6: step S404)

The reception frame analysis unit 42 discards the reception frame and ends the present flowchart.

(FIG. 6: step S405)

The CAN message extraction unit 43 delivers the extracted CAN message to the application processing unit 44. The application processing unit 44 performs predetermined processing using the CAN message.

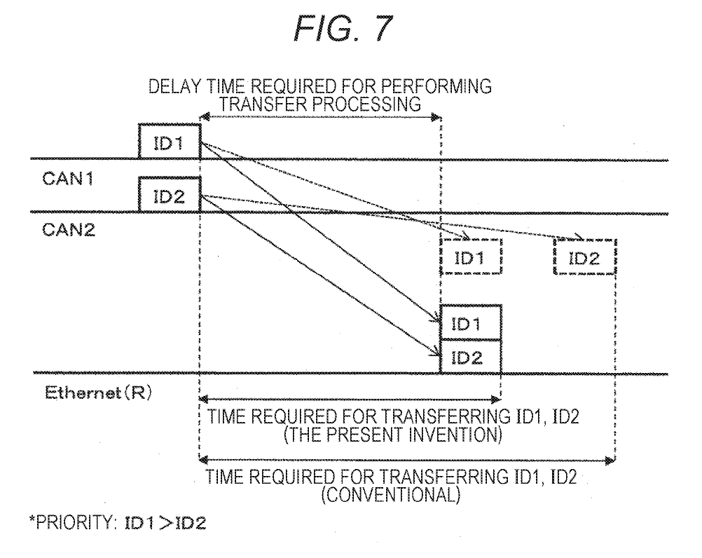

FIG. 7 is a time chart for explaining the time required for transferring a plurality of CAN frames whose transfer destinations conflict. Here, an example of transferring a CAN frame with a CAN ID of 1 and a CAN frame with a CAN ID of 2 is shown. It is assumed that the CAN ID=1 has higher priority.

In the conventional vehicle-mounted gateway device, when the transfer destination of the CAN frame conflicts, the CAN frame with higher priority is transferred first and then the CAN frame with lower priority is transferred. Therefore, a CAN frame with high priority is sent to the transfer destination with a delay time required for transfer processing, and a CAN frame with lower priority is sent with a still more larger delay.

In contrast, the vehicle-mounted gateway device 2 according to the present first embodiment packages, into the Data portion of one Ethernet frame, the CAN frame of which a transfer destination conflicts, and transfers the Ethernet frame, so that even if the CAN frame has low priority, it is possible to suppress the delay caused at the time of transfer.

### First Embodiment: Summary

In the vehicle-mounted gateway device 2 according to the present first embodiment, when the transfer destination of the communication frame relayed from the CAN network to the Ethernet network is conflicting, the ID portion and Data portion of the conflicting CAN frame are packaged into the Data portion of the Ethernet frame to be transferred. This eliminates the need for the CAN frame with lower priority to wait for transfer processing, and it is possible to greatly suppress the latency in transfer processing.

### Second Embodiment

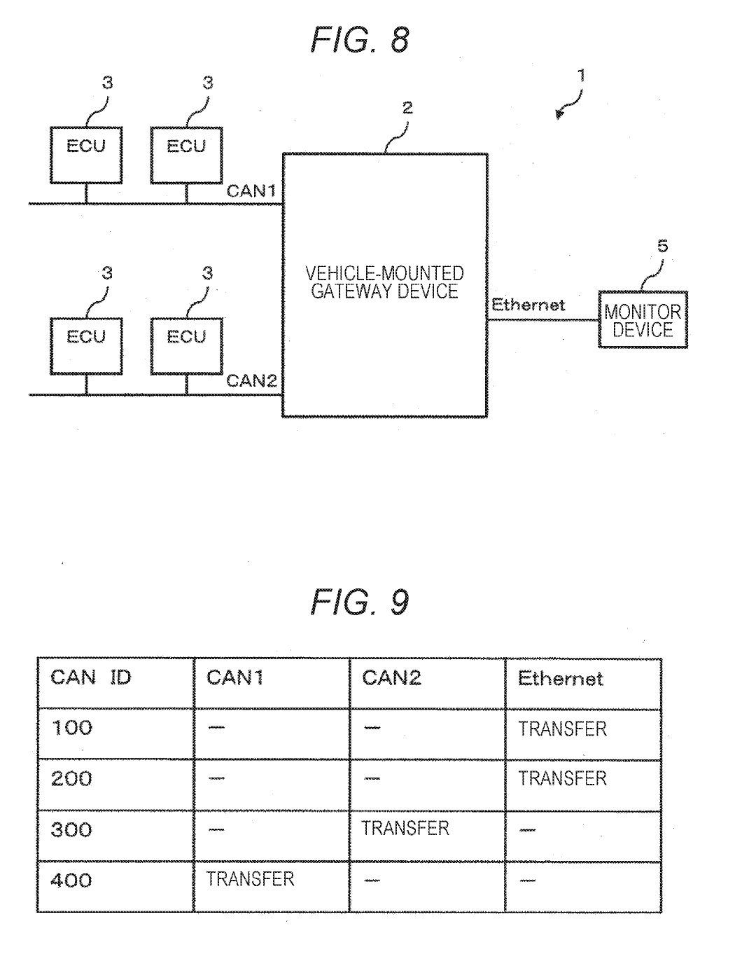

FIG. 8 is a configuration example of a vehicle-mounted network system 1 in which a monitor device 5 simulating an ECU 4 is connected to an Ethernet network in place of the ECU 4. The configurations of each device are similar to those of the first embodiment except for the monitor device 5. However, in order to distinguish between two CAN networks, the two CAN networks are hereinafter referred to as a CAN 1 and a CAN 2.

FIG. 9 is an example of a routing table 22 provided in a vehicle-mounted gateway device 2. The vehicle-mounted gateway device 2 transfers a CAN frame to the CAN network or the Ethernet network according to a route definition specified by the routing table. In an example shown in FIG. 9, for example, when the vehicle-mounted gateway device 2 receives a CAN frame with a CAN ID=100 or 200, the CAN frame is transferred to the Ethernet network.

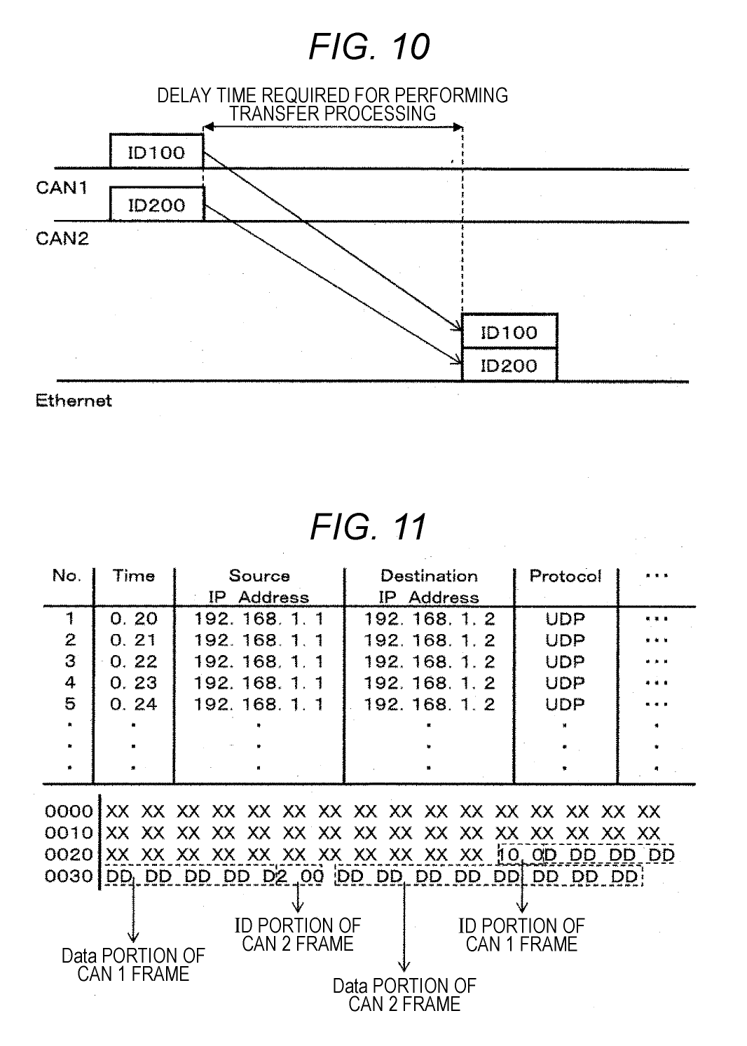

FIG. 10 is a time chart explaining processing in which the vehicle-mounted gateway device 2 transfers the CAN frame. Here, an example of transferring CAN frames with CAN IDs=100 and 200 will be described. According to the routing table described in FIG. 9, since all these CAN frames are transferred to the Ethernet network, a transfer destination conflicts. Therefore, the vehicle-mounted gateway device 2 packages an ID portion and a Data portion of these CAN frames into the Data portion of one Ethernet frame and transmits the Ethernet frame to the Ethernet network.

FIG. 11 is a diagram showing a result of monitoring the Ethernet frame shown in FIG. 10 by the monitor device 5. The Data portion of the Ethernet frame stores the ID portion and the Data portion of the CAN frame with the CAN ID=100 and also stores the ID portion and the Data portion of the CAN frame with the CAN ID=200.

<Regarding Modification of the Present Invention>

The present invention is not limited to the above embodiments, but includes various modifications. For example, the above-described embodiments have been described in detail in order to explain the present invention in an easy-to-understand manner, and are not necessarily limited to those having all the configurations described.

In the above embodiments, the ID portion and the Data portion of the CAN frame are extracted and consolidated. However, other portions may be extracted and consolidated as the Data portion of the Ethernet frame as necessary.

In the above embodiments, when the vehicle-mounted gateway device 2 transfers the communication frame, if the transfer destination network is a bus type network (for example, the CAN network), transfer may be performed without designating the destination. On the other hand, if the transfer destination network is a network (e.g., the Ethernet network) that communicates in 1:1 manner, the communication frame may be transferred to all terminals by broadcast communication, and alternatively, for example, a transfer destination terminal may be defined for each CAN ID on the routing table and transferred separately. Alternatively, the transfer destination may be determined by other appropriate methods.

In the above embodiments, two CAN networks and one Ethernet network are connected via the vehicle-mounted gateway device 2, but the configuration of the network connected via the vehicle-mounted gateway device 2 is not limited thereto. The number of the vehicle-mounted networks may be two or more, and the communication protocol used on each vehicle-mounted network may be other than the CAN and the Ethernet.

### REFERENCE SIGNS LIST

1 vehicle-mounted network system
2 vehicle-mounted gateway device
20 CAN physical interface
21 CAN reception buffer
22 routing table
23 transfer conflict determination unit
24 transfer data generation unit
25 Ethernet frame generation unit
26 Ethernet transmission buffer
27 Ethernet physical interface
3 electronic control device
4 electronic control device
40 physical interface
41 reception buffer
42 reception frame analysis unit
43 CAN message extraction unit
44 application processing unit
5 monitor device

1. A vehicle-mounted gateway device relaying communication between a first vehicle-mounted network transmitting and receiving a first communication frame having a first data portion and a second vehicle-mounted network transmitting and receiving a second communication frame having a second data portion of which size is smaller than that of the first data portion,
wherein the vehicle-mounted gateway device includes a generation unit generating the first communication frame by using the second communication frame,
the vehicle-mounted gateway device further includes a transmission unit transmitting the first communication frame generated by the generation unit to the first vehicle-mounted network, and
the generation unit consolidates the second data portions of a plurality of second communication frames to generate the first data portion in the first communication frame.

2. The vehicle-mounted gateway device according to claim 1, wherein
the generation unit consolidates the second data portions of the plurality of second communication frames of which transfer destinations are the same to generate the first data portion in the first communication frame, and
for the second communication frame of which a transfer destination is not the same, the generation unit generates the first data portion in the first communication frame without consolidating the second data portion.

3. The vehicle-mounted gateway device according to claim 1, wherein
the second communication frame further includes a data ID representing a type of data described by the second data portion, and
the generation unit consolidates the data IDs of the plurality of second communication frames into the first data portion in the first communication frame to generate the first communication frame.

4. The vehicle-mounted gateway device according to claim 3, wherein the generation unit extracts only the second data portion and the data ID from the second communication frame and consolidates the second data portion and the data ID into the first data portion.

5. The vehicle-mounted gateway device according to claim 1, wherein the generation unit sets size of the first data portion in accordance with the number of second communication frames consolidated in the first communication frame.

6. An electronic control device communicating via a first vehicle-mounted network,
wherein the electronic control device includes a reception unit receiving, in a format of a first communication frame via a vehicle-mounted gateway device, a second communication frame having a second data portion of which size is smaller than that of a first data portion of the first communication frame transmitted and received by the first vehicle-mounted network,
the electronic control device further includes an analysis unit analyzing a communication frame in a format of the first communication frame received by the reception unit, and
the analysis unit retrieves a plurality of second data portions from the first data portion of the communication frame in the format of the first communication frame received by the reception unit.

7. The electronic control device according to claim 6, wherein
the second communication frame further includes a data ID representing a type of data described by the second data portion, and
the analysis unit retrieves the data ID corresponding to the second data portion from the first data portion of the communication frame in the format of the first communication frame received by the reception unit.

8. A vehicle-mounted network system comprising:
a vehicle-mounted gateway device relaying communication between a first vehicle-mounted network transmitting and receiving a first communication frame having a first data portion and a second vehicle-mounted network transmitting and receiving a second communication frame having a second data portion of which size is smaller than that of the first data portion; and
an electronic control device communicating via the first vehicle-mounted network,
wherein the vehicle-mounted gateway device includes a generation unit generating the first communication frame using the second communication frame,
the vehicle-mounted gateway device further includes a transmission unit transmitting the first communication frame generated by the generation unit to the first vehicle-mounted network, and
the generation unit consolidates the second data portions of a plurality of second communication frames to generate the first data portion in the first communication frame.

9. The vehicle-mounted network system according to claim 8, wherein
the electronic control device includes a reception unit receiving, in a format of the first communication frame via the vehicle-mounted gateway device, the second communication frame having the second data portion of which size is smaller than that of the first data portion of the first communication frame transmitted and received by the first vehicle-mounted network,
the electronic control device further includes an analysis unit analyzing a communication frame in the format of the first communication frame received by the reception unit, and
the analysis unit retrieves the plurality of second data portions from the first data portion of the communication frame in the format of the first communication frame received by the reception unit.
